(19) United States
(12) Patent Application Publication
(10) Pub. No.: US 2011/0151150 A1
(43) Pub. Date: Jun. 23, 2011

(54) DYE RECEPTIVE POLYMER COATING FOR GRAPHIC DECORATION

(75) Inventor: Paul RAMSDEN, Lisbon, ME (US)

(73) Assignee: SURDEC LLC, Lisbon, ME (US)

(21) Appl. No.: 13/037,136

(22) Filed: Feb. 28, 2011

Related U.S. Application Data
(63) Continuation of application No. 11/743,042, filed on May 1, 2007.
(60) Provisional application No. 60/796,456, filed on May 1, 2006.

(51) Int. Cl. B41M 5/41; B41M 5/42; B41F 33/00; B41F 5/00

(52) U.S. Cl. 428/32.22; 428/32.37; 101/483; 101/212

(57) ABSTRACT

An image receptive medium comprising a semi-translucent polymer containing semi-translucent particulate capable of attenuating visible light and imparting color or haze is disclosed. The image receptive medium includes an image receiving layer containing particulate with various light attenuating properties. The image receiving layer can receive a dye through sorption or diffusion. The attenuating properties of the particulate act to enhance the quality of the image by obscuring background and scattering light to illuminate the dye. The result is a durable image requiring only a single layer which is highly visible on opaque, clear, or colored substrates.

### RELATED APPLICATIONS

This application is a continuation of U.S. patent application Ser. No. 11/743,042, filed May 1, 2007, which claims priority to U.S. Provisional Patent Application No. 60/796,456 filed May 1, 2006, assigned to the assignee hereof and the specification and drawings of which are fully incorporated by reference herein.

### BACKGROUND OF THE INVENTION

### Field of the Invention

The present invention relates to image receptive media, and more particularly, to an image receptive medium that provides for the aesthetic and durable graphic decoration of transparent, partially transparent and opaque surfaces, and its associated method and system.

### Background

Transfer printing generally incorporates sublimation; a phase change of a dye or pigment which converts from solid to gas without an intermediate phase. Deposition is the reverse of sublimation; namely a gas converting to a solid without an intermediate phase. Certain printing dyes known as disperse-dyes, sublimate at temperatures typically ranging from 280 F-450 F. Disperse dyes turn gaseous under the influence of heat and penetrate substantially organic polymers that are heated above their softening points. The dyes migrate through the matrices of these polymers by diffusion, returning to solids on cooling by deposition. In the case of porous or inorganic substrates transfer dyes and pigments migrate by the physical principles of sorption as opposed to diffusion. Inorganic materials that support the migration of phase-change colorants tend to be porous materials that breathe at higher temperatures, in other words their pores expand and gases can penetrate into them by principles of adsorption. Inorganic materials generally have substantially higher softening points than organic materials and so accepting dye sublimation by diffusion is not a reality. However, at lower temperatures more suited to phase change colorant activation, certain dyes and pigments can be impregnated into porous materials such as anodized aluminum. Upon cooling the pores close trapping in the dyes which return to solid state by deposition.

Dye sublimation is one such process of transfer printed graphic surface decoration. Phase-change disperse dyes are transferred or affixed to a receptive polymer with heat and pressure. The dyes, in their inactive state are printed in a printing device onto a transfer medium, which usually comprises paper, foil, textile or film. The dyes are subsequently activated by heat and simultaneously transferred to the receptive organic polymer in a device capable of delivering heat and pressure to the dye-polymer interface.

Sublimation, in the context applied in the art of graphic surface decoration by transfer printing, was developed in the late 1950's. The first recorded patent known to this inventor relating to the art was French patent no. 1,223,330. Since this time the commercial application has grown steadily although in the last fifteen years this multi-faceted industry has seen considerable growth; this recent growth curve due in part to improved techniques, equipment, materials and dye and receptive polymer formulations.

Dye sublimation has long been a process employed to decorate textiles; principally polyester flags, banners, upholstery and apparel. Since the mid 1990's the dye sublimation process has been increasingly employed to decorate rigid substrates. These substrates include metals, plastics, ceramics and even wood. Increasingly dye sublimation is employed to decorate OEM products including consumer items.

Other graphic surface decoration technologies include direct printing, laminating, and the dip process; however all of these processes are limited to applying graphics to the very surface of the substrate being decorated; thereby requiring post-print protective coatings to be applied to provide the necessary degree of durability for consumer items and to prevent the image from being chemically degraded, scratched, worn or washed off.

Contrary to other forms of graphic surface decoration, dye sublimation transfer printing diffuses the colorants beneath the surface at the time of activating and transferring the image; and in most cases does not require a post-print protective coating to be applied for the product to meet the needs of the end user.

There is a growing and significant demand for durable and economical graphic surface decoration. Dye-sublimation is increasingly the preferred solution; considered by industry to provide the most aesthetic, durable and economically-viable graphic surface decoration.

Sublimation decoration requires that phase-change dyes or pigments are deposited upon a transfer medium by a printing device, typically ink jet, bubble jet, laser, offset press, rotary screen, gravure press, flexo press or other means, the selection of which would be well known to those of average skill in the art of digital and conventional printing. The role of the transfer medium is to carry the image from the printer to the surface to be decorated. The transfer medium is designed to accept the image accurately and temporarily, fully releasing it during the transfer process. The printing device reproduces a digital image, usually rendered as a mirrored image of the stored digital-graphic file, which is disposed upon a transfer medium; usually comprising of paper, film, foil, or textile. Rendering a mirrored orientation is typical due to the transfer-medium being subsequently applied face down onto the receptive-medium when transferring it to the receptive medium. Hence the transfer step entails a second horizontal flip in orientation, reproducing the original view on the decorated surface. The exception to this principal is when the image is going to be viewed through a transparent medium upon which it is to be applied, such as would apply when decorating glass. In this case the user of the art may elect to not reverse the orientation of the image when it is printed onto the transfer medium.

Succeeding deposition of the sublimation dyes or pigments upon the transfer medium, the medium is applied, imaged side toward the receptive surface, onto a polymeric or polymer coated substrate or porous substrate that is capable of accepting the transfer of the image by the principles of diffusion or sorption respectively. The transfer is typically instigated by the application of heat and pressure delivered to the interface between the printed transfer medium and the receptive surface. Consequently the disperse dyes or transfer pigments are activated into their migratory state upon which they diffuse or adsorb into the adjacent receptive medium.

Surfaces receptive to the diffusion of sublimated disperse dyes are almost without exception substantially organic in chemistry. The polymer must readily soften in the temperature range of 280-420 F synchronized to the activation of the transfer dye. In the case of organic polymers the rigid molecular matrix softens and the gaseous or liquefied dyes or pigments diffuse through it. Generally the less rigid the matrix, and the lower the crosslink density of the polymer, the easier it is for the dyes to penetrate and diffuse through it. Conversely the higher the crosslink density, and the larger the ratio of inorganic material contained within the polymer, the greater the resistance imposed upon the migration of the colorant. As the receiving polymer and colorants diffused within it cools, the matrix becomes rigid once again, and the colorant returns to a solid, locking in the colored particles within the host polymer.

Most transfer printing that embeds an image or design into a receptive medium is accomplished using the sublimation technique. However transfer printing also includes a melt printing process described in several patents and patent applications including: U.S. Pat. No. 4,587,155 to Durand; U.S. Pat. No. 4,670,084 to Durand; U.S. and Pat. No. 4,668,239 to Durand. According to Durand, the image is embedded into the receiving layer by heating a dye to a temperature above the melting point but below its vaporization temperature so the dye will diffuse into the softened plastic substrate.

Dyes and pigments suited to transfer printing, are otherwise known as phase-change colorants and are to a varying degree transparent and translucent. The optical transmission is relative to the composition of the colorant, its spectral absorbance curve, its density, its loading level, and the refractive index of both the colorant particle and the host medium within which it is suspended. It is understood by those conversant with the art of sublimation transfer printing that if an image is transferred onto a dark surface then said image will likely appear darker and less colorful than in its original state. This is because much of the light passing through the imaged layer is being absorbed by the substrate behind it as opposed to being reflected which would be the case were the substrate to be light in color. The greater the absorbance the less the dyes are illuminated and thus the darker the image appears. This relationship can be compared to a photographic slide image appearing subdued or scarcely visible when placed upon a dark background; becoming vibrant and clearly visible when viewed upon a light colored background with a light shone upon it. It is further understood by those conversant with the art of sublimation transfer printing that if an image is transferred into a pigmented receptive polymer the diffused colorants are obscured by the pigments in the polymer. Pigments employed in coatings and paints are substantially larger and more opaque than the colorant particulate used in transfer printing colorants. Generally pigments in coatings are employed in a volume of 10-40% by weight of solids. Dyes diffused into pigmented coatings are obscured by the size and opacity of the pigment particles. Graphic dyed images transferred into pigmented coatings appear washed out, and any colors lighter than the pigment itself become completely overpowered and lost in the coating. Only dyes darker than the pigment and only dyes at the surface of the pigmented coating are visible. This means a loss of color in the image and a reduction in visible dye which reduces the density of the color as well as the overall resistance of the image to degradation; dyes at the surface of a coating are more prone to degradation as they are afforded less protection by the polymer and its UV absorption.

To accommodate the aforementioned physical aspects of dye based surface decoration the existing art employs a practice of applying clear polymer coatings upon white or light-colored reflective substrate. The dyes are transferred into the clear polymer where they are illuminated by light reflecting off the adjacent underlying layer. In OEM applications where the substrate is for example dark grey steel, the OEM is required to coat the metal with a light pigmented coatings, and then apply a secondary clear polymer coating. Due to the nature of coating applications and the economics and logistics involved this is an undesirable aspect of dye sublimation printing.

Based upon similar principles to those discussed, it is common knowledge in the art of sublimation transfer printing that if an image is transferred onto a clear substrate then the image will exhibit low color density and a high degree of transparency; the lighter the color the greater the transparency and translucency. This is because light passing through the imaged layer experiences minimal attenuation; thus the dye and the medium transmit a high percentage of the light. Depending upon what object is positioned or passes behind the decorated object the colors, the density and the overall appearance will change accordingly. Within the art it is commonplace that an opaque polymer is deposited either prior or subsequent to the transfer of the image, on the receptive medium; more specifically on the opposite side of the medium to the glass or transparent substrate being decorated. By so doing however, the decorated medium forfeits translucency and the diffused image is prevented from being visible from the coated side. In the case of graphics being fused between two pieces of glass, the ability to see the image from only one side is a drawback; as is the lack of translucency and inability to illuminate the image from light of all incidences.

Relative to both the art of decoration of dark and transparent substrate, prior disclosures detail a method of enhancement of sublimed image clarity by a bright or reflective layer being positioned behind the sublimation-receptive layer. In this regard Sherman et al. in U.S. Pat. No. 5,856,267 state that the base coat ideally “ . . . has a pigment such as titanium dioxide within it to provide a solid color background for printing’ ; additionally Poole in U.S. Pat. No. 5,962,368 states “Before application of the coating into which the sublimation ink decoration will be imprinted, a white base coat background may be pre-applied to reflect the sublimation ink color or decoration.”

Sherman et al., in U.S. Pat. No. 5,976,296, states that, “The surface of the object to be printed preferably comprises a base coat and a top coat . . . . ” Sherman et al. further suggest in reference to the base coat, “[P]referably it is pigmented with, for example, titanium dioxide in order to provide a solid color background for printing.” O'Brien, III, in U.S. Pat. No. 6,004,900, suggests integrating the reflective element into the sublimation-receptive coating. In particular, O'Brien III states that, “[A]n outer layer of the article . . . that includes an effective amount of an optically light pigment.” Additionally, O'Brien states that, “[T]he pigment can be or include titanium dioxide.” likewise Home et al in U.S. Pat. No. 7,108,890 states “This image is printed in accordance with this invention on a substrate where the substrate's surface has been first provided with a transparent polymeric top coating

From the aforementioned statements it may be concluded that prior hereto, in both the case of decorating darker and transparent substrate, optimal dye-sublimation processing has required that both a clear polymer and a pigmented polymer are applied to the substrate; however this is a significant shortcoming in most industrial applications. In industry, the application of 2 or more coatings to enable a product to be decorated by the dye-sublimation process, is more often than not, neither logistically nor economically viable. In many cases the requirement to do so would result in the OEM or decorator seeking other means to decorate their product. Multiple powder coating applications upon metal for example would be very difficult to apply due to the nature of electrostatic deposition, overcoming these difficulties is complex, expensive, and fraught with complications.

In an attempt to overcome this obstacle, prior art has employed a practice of using a reduced loading level of pigment in a dye receptive coating. Reducing the volume of pigment reduces the degree of obscurity of the dyes and increases the depth of dye penetration that remains visible. The sacrifice in hide strength of the coating is not as critical in a dye-sublimation coating on the condition that the substrate is not visible through it after decoration. While reducing pigment loading levels does to some degree improve the quality and performance of the dyed image the shortcomings are not resolved. The pigment does still obscure the dye, and dyes of a lighter color than the pigment do still become lost in the coating; for example the transfer of solid black color appears speckled or a mottled dark grey.

Reducing the pigment loading level too much results in increasing the transparency of the coating and enhances the appearance of speckling. Transparency in the coating will result in the background interfering with the image. In the case of metals for example the sheen and color of the metal may cause unwanted interference on the appearance of the image.

It would clearly be a welcome and significant advance to the art of transfer and diffused-dye based printing, to only employ one coating that would be suitable for dark, colored or transparent substrates; and that enables embedded dyes to appear solid, opaque, vibrant and dense within it. In fulfillment of this desirable advance in the art, the present invention provides for an image receiving medium that accepts and protects the dyes, renders them, to a customizable degree opaque; and enhances their density and vibrancy.

### SUMMARY OF THE INVENTION

The present invention provides an image receptive medium that includes a substrate and an image receptive layer with visible light attenuating properties that is operable to receive an image through at least one of diffusion and sorption.

Additionally, the present invention provides an imaging system that includes an image receptive medium that includes a substrate, at least one visible light-attenuating image-receiving layer arranged on the substrate operable to receive an image through at least one of diffusion and sorption. The system also includes a transfer medium comprising an image to be transferred to the image receptive medium by at least one of diffusion or sorption.

Also, the present invention provides an imaging system. The imaging system includes a processor operable to accept and render an image and to transmit the rendered digital file to a printer. The system also includes a printer operable to receive the file and print the image on a transfer medium. A transfer device is operable to apply at least one of heat and pressure to the transfer medium and an image receptive medium to effect transfer of the image from the transfer medium to the image receptive medium through at least one of diffusion and sorption.

Furthermore, the present invention provides a method of making an image receptive material. The method includes depositing at least one image receiving layer on a substrate. The image receiving layer comprises light attenuating particulate comprising at least one of translucent glass particulate, translucent particulate of any composition with higher refractive index than the host polymer, translucent particulate with a refractive index higher than 1.2, translucent particulate with at least one dimension less than 400 nm across, and translucent particulate with haze imparting and light scattering properties. The image receptive layer is operable to receive an image through at least one of diffusion and sorption.

Furthermore, in various embodiments, the present invention provides a method of enhancing the image receptive material by incorporating fluorescent and photo-luminescent particulate within the image receiving layer or an adjacent layer. Mechanisms of converting ultraviolet energy to visible light, and releasing stored light energy further illuminate diffused graphics and improve the hide characteristics of the receiving layer.

The present invention enhances the quality of the image embedded within the receiving medium while reducing costs of the decoration process; further increasing the body of persons and entities, both skilled and unskilled in related coating arts, that stand to use and benefit by this method of custom graphics application. Some embodiments of the present invention provide a system that is highly environmentally compliant, employing powder coating technology and radiant energy curing systems, while providing durability and highest performance of the medium following the application of the image. This is achieved without the need for additional protective layers. The present invention can employ water-based or solvent-based chemistries; and air dry systems, catalysed coatings, and both radiant energy or thermoset curable chemistries.

As would be well known to those skilled in the coating arts, compatible coatings may comprise a plurality of chemistries, produced and applied in powder or liquid form, by electrostatic means or otherwise. A broad range of coatings, chemistries and application and curing processes are therefore compatible with the present invention.

Dyes impregnated within the polymer matrix or porous substrate containing these light scattering particulate have been proved to be denser, richer, more vibrant, more opaque and more durable than the conventional art provides.

Still other objects and advantages of the present invention will become readily apparent to those skilled in the art from the following detailed description, wherein it is shown and described only the preferred embodiments of the invention, simply by way of illustration of the best mode contemplated of carrying out the invention. As will be realized, the invention is capable of other and different embodiments and its several details are capable of modifications in various obvious respects, without departing from the invention. Accordingly, the drawings, wherein like reference numerals represent like features, and description are to be regarded as illustrative in nature and not as restrictive.

### BRIEF DESCRIPTION OF THE DRAWINGS

FIG. 1 represents a schematic view of the process of decorating an image receptive medium employing one embodiment of the present invention. A digital file 10 has been rendered for printing in a digital file rendering device 12 such as a computer. A printer 14 prints the rendered device onto a transfer medium. Separately an image receiving translucent polymer containing translucent light scattering particles 16 is deposited upon a substrate to produce an image receiving medium 90. The printed transfer medium and image receiving medium are subject to heat and pressure while in contact within a heat pressure delivery device 3 which subsequently produces an imaged substrate 100.

FIG. 2 represents a cross-sectional view of an image receptive medium (A) prior to, (B) during, and (C) subsequent to the diffusion of dye through the image receiving layer in one embodiment of the present invention.

FIG. 3 represents a cross-sectional view of a decorated image receptive medium 1 in one embodiment of the present invention indicating the effect of the light scattering additives 20 on the illumination of the embedded dyes 30. In this example the haze imparting additives are glass microspheres 20 with a higher refractive index than the host polymer

FIG. 4 represents a cross-sectional view of a decorated image receptive medium 1 in one embodiment of the present invention indicating the effect of the light scattering 22 additives on the illumination of the embedded dyes 30. In this example the haze 25 imparting additives comprise nanoparticulate 20 with one or more dimension under 400 nm

FIG. 5 represents a cross-sectional view of a decorated image receptive medium 1 in one embodiment of the present invention indicating the effect of the light scattering additives 24 on the illumination of the embedded dyes 30. In this example the haze imparting additives 24 comprise semi-transparent micronized pigment.

FIG. 6 represents a cross-sectional view of a decorated image receptive medium 1 of one embodiment of the present invention containing optical brighteners 26 to enhance the illumination of the embedded dyes 30 exposed to ambient light 50.

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

Processing industrial dye-sublimation involves a complex list of variables; among them and perhaps the most intricate of them, are the formulations of the dye-receiving polymer; and the dye based is that will be employed to decorate them.

In general terms, the present invention provides an imaging medium. The medium includes a substrate 40. At least one image-receiving layer 1 is arranged on the substrate 40. The image-receiving layer 1 receives an image through sublimation and/or diffusion of dyes and/or pigments from a transfer medium.

In specific terms the present invention relates to the image receiving layer that accepts the dyes or pigments employed in the transfer process. Along these lines, the present invention introduces a method of displaying and illuminating graphics by disposing them within a medium that is capable of capturing ambient light and scattering it to enhance the appearance and performance of the decorated medium. For the purposes of the present invention the term scattering shall include reflecting, refracting, and absorbing; and any combination thereof.

The principle aspect of the present invention is the use of semi-translucent light scattering particulate as an additive disposed within a translucent polymer which is capable of receiving dyes by diffusion or adsorption. The translucent light scattering additives scatter light which enters the host polymer, which in turn renders dyes embedded within the host polymer more opaque; and thus increases their density and vibrancy. This increased opacity, which is derived from the optical effects of the translucent particulate within the polymer as opposed to an opacity of the particulate itself, in turn conceals the underlying substrate; without the optical properties of the underlying substrate adversely affecting the appearance of the dyes.

To support a better understanding of the concept of this invention a comparison can be made to sand blasting a sheet of glass. Prior to sand blasting, the glass may be assumed to be optically clear. The flat surface of the glass reflects some light, and allows a high degree of light transmission and transparency. However, if the glass is sand-blasted, the surface of the glass becomes undulated, with pits and valleys across it on a microscopic level. Light striking the surface is now scattered in a plurality of directions, some reflected, some passing through it, but a high percentage of it scattering laterally in all different directions. The result is a considerable reduction or elimination of the transparency of the glass. Despite this opacity however the glass does remain translucent and shining a light on it from one side will still result in light being visible from the other side albeit the source of the light will no longer have clarity due to the reduction in the transparency of the glass. This is the same principle as is employed in frosted shower doors or back lit diffusion panels that take light and scatter it enabling an even diffusion of light across a broad area.

Taking this concept one stage further, if the original clear glass is placed on a grey background prior to sand blasting, the glass will assume the color of the background, as light will not be prevented from reaching the background and being absorbed and reflected according to the spectral absorbance of the color of the background. However, placing the sand blasted glass on the grey background will result in considerably less influence on the appearance of the glass, retaining much of the apparent whiteness that was rendered by the sand blasting. This is due to the fact that much of the light is not reaching the grey background is being scattered on the surface of the glass.

The present invention takes this principle and applies it to image receiving media; embedding the effect throughout the media, causing the light scattering to create an opacity through the full depth of the dye column; rendering the dyes more intense, less affected by the background color or transparency of the substrate, and increasing the opacity of the image as a whole.

The invention introduces a number of novel ways with which to obtain this effect, the principle being that the light scattering particles have a high degree of transparency as individual particles, yet have a high refractive index. In this manner the image receiving layer can host colorants without diminishing their color or intensity, while not obscuring and thus fading the image by the presence of the particulate itself, which would be the case were conventional means and pigments to be employed. Very high refractive indices can result in a high degree of reflected light further diminishing the effect of having a dark background behind the image receiving layer. Certain glass particles for example will have retro reflective properties to them providing a very high degree of illumination of the image receiving layer.

A number of ways of creating this optical effect within the image receiving layer are presented and remain within the theme of this invention. In so far as printing and transfer of the image is concerned, much of this aspect of the process remains conventional art.

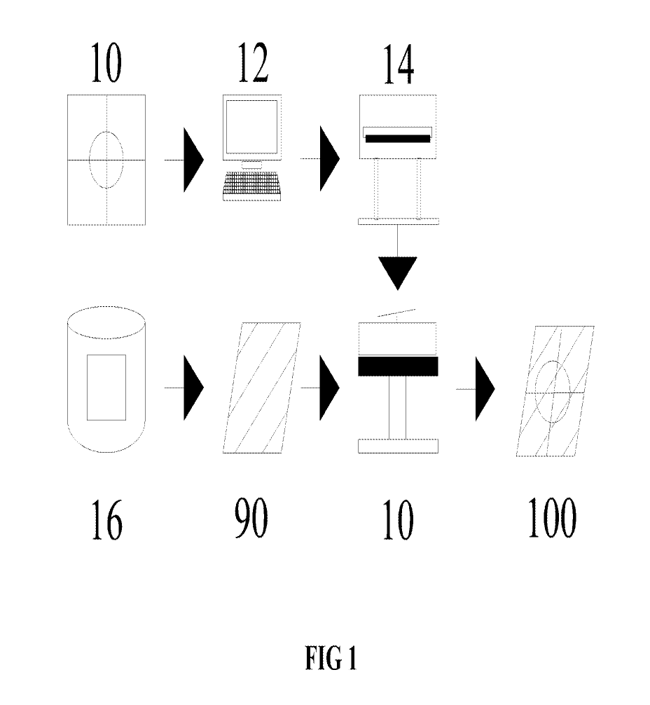

FIG. 1 depicts an overview of the entire process of decoration. In the first instance a graphic file is prepared for printing. The graphic file may be generated using conventional digital means, and is sized and oriented according to the surface being decorated. The file may be stored using conventional digital storage means and is transmitted to the printer using conventional driver and RIP software, as would be well known by those in the art of digital printing. The printer employed would receive the digital file, and commence depositing the ink onto a transfer medium.

In the field of conventional printing, a graphic ink is deposited by a printer onto paper or other substrate, which would be intended to retain and to the greatest degree possible protect the image. In contrast to the conventional art of direct graphic printing, the process of transfer printing deposits is that contain phase-change colorants in their un-activated state, and deposit them onto a medium that while intended to receive them accurately, is designed to release them in a subsequent stage of processing. This usually requires that the transfer medium has been pre-coated with a release layer that accepts the ink, allowing it to dry, and then releasing the dried colorants upon the application of heat and pressure.

The diagram also shows a polymer being prepared by the addition of particulate that when suspended in the polymer will to some degree attenuate light. The present invention relies on optical interference; namely curtailing the passage of light through the polymer; scattering it to illuminate dyes contained within it, increasing their vibrancy, density and opacity. The host receptive polymer need not be modified in any other manner to comply with the essence of the present invention.

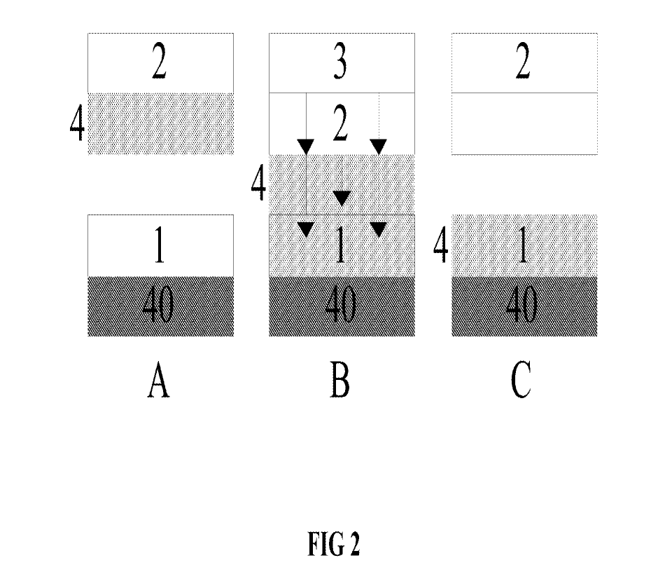

FIG. 2 depicts the transfer of the activated transfer colorants from the printed transfer medium to the receiving layer. In response to the application of heat and pressure, the phase-change colorants are activated, converting from solid state to gaseous or liquid; one that will readily diffuse or adsorb into a receptive layer. Simultaneously the receptive layer softens, or in the case of inorganic materials the pores within it expand; in either case rendering the receiving layer hospitable to the activated colorants. At this time the colorants transfer from the medium upon which they were printed, and become embedded within the receptive layer, thus completing the transfer. The amount of heat energy, pressure and time required instigating and carrying out the transfer and the speed and depth of migration of the dyes once transferred into the receiving layer depends upon several factors including the chemical and physical composition of the colorants and the receiving layer. Such factors would be known to those skilled in the art and as such are not necessarily detailed herein for a full disclosure of the present invention to be provided.

In another aspect of the present invention the translucent light scattering particles possess a higher refractive index than their host polymer. Principle examples of such particulate include micronized glass spheres, flakes and other glass particles. It is also proposed by the present invention that the particulate exhibit a refractive index greater than 1.2; and that the host polymer may have a refractive index of more or less than 1.2 without straying from the theme of the invention.

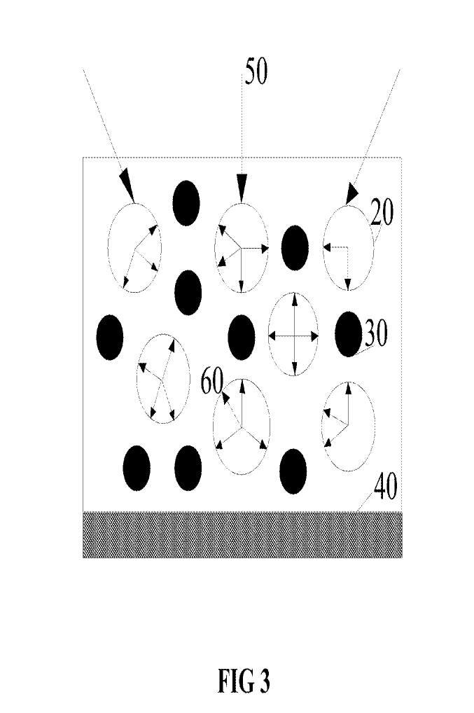

FIG. 3 illustrates the principle of light scattering additives disposed within a dye receiving layer. In this example an optically clear glass substrate has been selected and coated with a powder coating containing glass microspheres. The powder coating comprises polyester-urethane chemistry and prior to the addition of the glass microspheres was optically clear. The coating was modified by the loading of 30% by weight of the glass microspheres, which possess a refractive index of 1.9 and an average particle size of 5-10 microns. The coating was applied with a film thickness of 100 microns. The resulting applied coating exhibits a high haze, translucent, semi-opaque finish with the effect of sandblasted glass. The coating, receptive to sublimation dyes, was processed according to the principles depicted in FIG. 1; receiving the dyes well, which diffused throughout the film from the surface to its interface with the glass, and which resulted in a vibrant, opaque graphic finish.

The refraction of light causes the dyes to receive incident light from all angles, illuminating the dye particle and increasing the density of the imparted color. The increased density of the color and the attenuation of passage of light through the host layer serve to also increase the opacity of the dyed medium and therefore the hide of the underlying substrate.

In another aspect of the present invention the translucent light scattering particles are nanoparticles with at least one dimensional axis under 400 nm, being the smallest wavelength of visible light; therefore particles under this dimension are to some degree translucent even if not wholly transparent. Transparency and particle width are inversely proportionate; therefore the smaller the particle size, the greater the transparency. Nanoparticles of different hues can be employed without straying from the theme of this invention, however retaining the dimension of one axis smaller than the smallest wavelength of visible light ensures that a degree of translucency will be present.

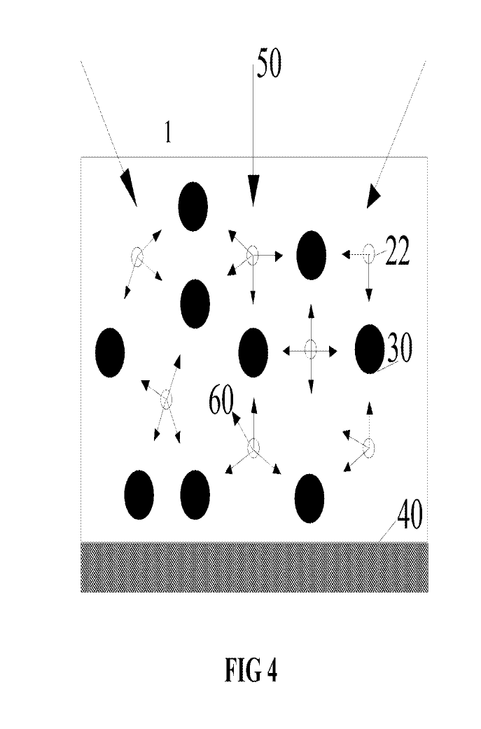

FIG. 4 provides an illustration of this principle of light scattering. In this example the image receiving layer contains spherical nanoparticles of aluminum oxide with a mean width of 100 nanometers. The Al₂O₃ particles are coated to resist agglomeration as would be known by those conversant in the art of nanotechnology based material sciences. In this example the particulate has been suspended in an aqueous dispersion and integrated into a homogenous blend of the dispersion and a thermoset aqueous urethane clear coating with a loading level of 10% by weight. The alumina introduces a high degree of haze to the coating which offsets the grey appearance of a steel substrate upon which it has been applied. The particle size of the alumina however, remaining well below the 400 nm wavelength of visible light, enables the particles to retain translucency and thus not diminish the vibrancy or intensity of the dyes embedded with the image receiving layer.

Nanoparticles of alumina are known in the art of material sciences are providing a high degree of abrasion resistance and in recent years coating formulations have benefited from the integration of Al₂O₃ nanoparticles. Clear coatings have also benefited as nanoparticles have a high degree of transparency, the smaller the particle, the lower the loading level, and the more colorless the original material; the greater the transparency and translucency of the resultant hybrid polymer. For the purpose of this invention however maximizing the transparency of the coating is not the intention; instead reducing the transparency while retaining a degree of translucency is the object. Therefore as opposed to low loading levels of the smallest scale nanoparticles, which would be preferred in optimising the abrasion resistance of clear coatings for example, the present invention benefits from higher loading levels of particles in the 50-400 nm range.

If it is desirable to introduce a hue to the coating, thereby creating a base color for the image, then this can be achieved by the use of nanoparticles that impart that hue. For example iron oxide nanoparticles impart a yellow red or brown hue depending upon their size, shape and loading level. Carbon based nanoparticles lend a grey or black appearance. Despite the particles being under 400 nm, increasing their size and loading levels will impart a hue and increasing degree of opacity to the coating within which they are contained.

In another aspect of the present invention partially transparent particles are employed to create haze. Examples of suitable partially transparent particles include calcium carbonate, zinc oxide, kaolin clay, and waxes and other material compositions known to impart haze without the very high degree of light scattering associated with high-hide pigments such as titanium dioxide.

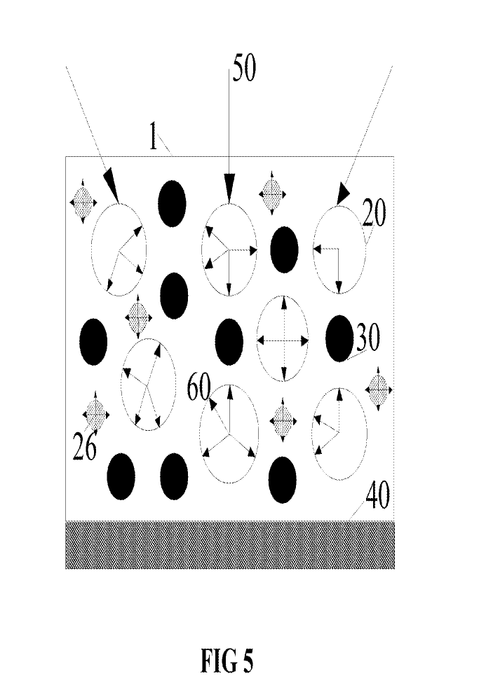

FIG. 5 provides an illustration of this principle of light scattering. Certain particles suited to be integrated into coating formulations, and in many cases capable of lending attributes to the coating performance, are well suited to imparting a degree of haze to the coating without deleterious effects being imposed on the dyes suspended within the image receiving layer. FIG. 4 depicts a stone tile which in its uncoated state is off-white with dark streaks and significant unevenness to its coloring. While in an undecorated state these features are aesthetic and considered part of the natural beauty of the stone, they are considered in many cases to interfere with the appearance of graphic decoration that may be desired to be placed upon them. Also it is often the case that the stone is not as white as would be considered optimal for the dye diffusion process, rendering the appearance darker than would be desirable. To employ glass particulate or nanoparticles of metal oxides may well introduce an undesirable degree of sparkling or reflection that on stone may not be conducive to replicating the smooth matte finish associated with tumbled stone.

FIG. 5 therefore depicts the use of haze imparting particulate into the coating; namely in this example calcium carbonate. Other suitable additives include waxes, silicates, matting agents, zinc oxide, kaolin clay, and other semi-transparent materials. In the present example the calcium compound is integrated into the image receiving layer in a mill reducing the particulate size and enhancing homogeneity. The additive was incorporated into a solvent borne 2-part solvent-borne urethane coating at 20% by weight of solids. The coating was applied on a stone tile in two layers, each drying to 1 mil dry film build.

In another aspect of the present invention the dye receiving layer is host to more than one of the aforementioned translucent light-scattering particulate either independent of each other or attached to each other. Building dynamic and smart image receiving layers is possible in this regard; increasing hide, therefore reducing transparency, improving light scattering, therefore improving the lightness of the surface, in conjunction with retaining translucency of the host polymer, is possible by employing cooperative particulate.

In FIG. 3 an image receiving layer is presented with a light scattering additive possessing a high refractive index. In FIG. 4 an image receiving layer is presented with particles under 400 nm in dimension that are capable of retaining translucency while imparting hide. In FIG. 5 the opacity is derived from haze imparting additives that possess a high degree of translucency and transparency in their individual micronized form. The present invention provides that in addition to these mechanisms of attenuating transparency while retaining some translucency, they may be combined without straying from the theme of the invention. In most cases the additives defined may be integrated without deleterious effects and in some cases improved effects can be derived from them being combined. For example coating glass microspheres with nanoparticles of titanium dioxide can impart a greater degree of whitening to a powder coating and its integration within an image receiving polymer made quite straightforward, when compared to other means of integrating nanoparticles into coatings.

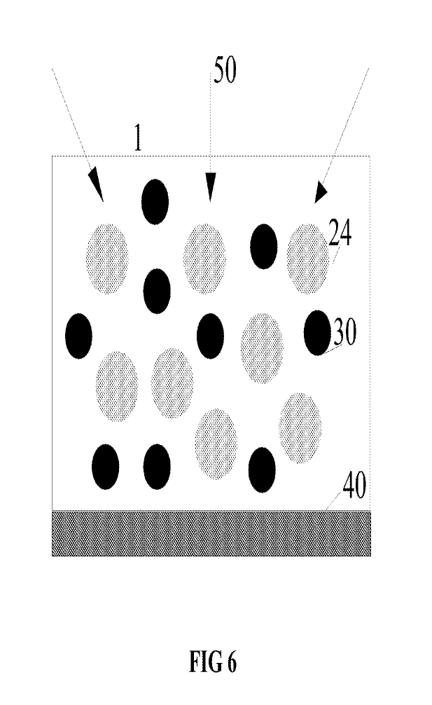

In FIG. 6 the image receiving layer has been further enhanced with optical brighteners, particles that are fluorescent, converting ultraviolet energy to a visible whitish blue color. These fluorescent particles serve to further enhance the brightness and whiteness of the image receiving layer. Typically optical brighteners are included in coating compositions in very low loading levels, and are avoided in long term external applications due to the effects of prolonged ultraviolet exposure.

The foregoing description of the invention illustrates and describes the present invention. Additionally, the disclosure shows and describes only the preferred embodiments of the invention, but as aforementioned, it is to be understood that the invention is capable of use in various other combinations, modifications, and environments and is capable of changes or modifications within the scope of the inventive concept as expressed herein, commensurate with the above teachings, and/or the skill or knowledge of the relevant art. The embodiments described hereinabove are further intended to explain best modes known of practicing the invention and to enable others skilled in the art to utilize the invention in such, or other, embodiments and with the various modifications required by the particular applications or uses of the invention. Accordingly, the description is not intended to limit the invention to the form disclosed herein. Also, it is intended that the appended claims be construed to include alternative embodiments.

While specific embodiments have been illustrated and described, numerous modifications come to mind without significantly departing from the spirit of the invention and the scope of protection is limited by the scope of the accompanying claims.

What is claimed is:

1. An image receptive medium comprising:
a substrate and an image receiving layer operable to receive an image through diffusion or sorption, the image receiving layer further comprising
a polymeric binder; and
a plurality of partially translucent light scattering particles, the particles having an average size of less than 400 nanometers.

2. The image receptive medium according to claim 1, at least a portion of said plurality of particles having a refractive index of greater than 1.2.

3. The image receptive medium according to claim 1, wherein at least a portion of said plurality of particles is retro-reflective.

4. The image receptive medium according to claim 1, wherein said plurality of particles comprises glass microspheres with a refractive index that is higher than the host polymer.

5. The image receptive medium according to claim 1, wherein said particulate comprises glass particles having an average size between about 50 nanometers and about 400 nanometers.

6. The image receptive medium according to claim 1, wherein said plurality of light scattering particles comprises pigment.

7. The image receptive medium according to claim 1, wherein said image receiving layer further comprises a color imparting translucent particulate having an average size equal to or less than 400 nm.

8. The image receptive medium according to claim 1, wherein said plurality of light scattering particles is of a higher refractive index than the host polymer.

9. The image receptive medium according to claim 1, wherein said image receiving layer further comprises a plurality of fluorescent particles.

10. The image receptive medium according to claim 1, wherein said polymeric binder comprises an organic or inorganic-organic polymer.

11. The image receptive medium according to claim 1, wherein said polymeric binder has a loading level of the plurality of light scattering particles of between about 5 percent and about 30 percent by weight.

12. The image receptive medium according to claim 1, wherein said image receiving layer has a thickness of between 10-500 microns.

13. The image receptive medium according to claim 1, wherein said substrate is of a dark color or has a low index of reflectivity, and wherein said image receiving layer enables a received image via diffusion or sorption to be of increased visibility due to said particulate.

14. The image receptive medium according to claim 1, wherein the substrate is of a light color or has a high index of reflectivity, and wherein said image receiving layer enables a received image via diffusion or sorption to be of increased visibility due to said particulate.

15. The image receptive medium according to claim 1, further comprising a received dye, wherein said image receiving layer receives said dye by at least one process selected from the group consisting of diffusion, sublimation, and sorption.

16. The image receptive medium according to claim 1, wherein said image receiving layer is transparent.

17. The image receptive medium according to claim 1, wherein said image receiving layer is translucent.

18. The image receptive medium according to claim 1, wherein said image receiving layer is opaque.

19. The image receptive medium according to claim 1, further comprising a color altering material for altering a color of an image produced on said medium.

20. An imaging system comprising:
an image receptive medium comprising a substrate and an image receiving layer arranged on the substrate to receive an image through at least one of diffusion and sorption, wherein the image receiving layer comprises
a polymeric binder;
a plurality of partially translucent light scattering particles having an average size of less than 400 nanometers, and
a transfer medium comprising an image to be transferred to the image receptive medium by at least one of diffusion and sorption.

21. An imaging system comprising:
a processor operable to modify an image and to transmit the image to a printer,
a printer operable to receive the image and print the image on a transfer medium,
an image receptive medium comprising
an image receiving layer having a polymeric binder and a plurality of partially translucent light scattering particles having an average size of less than 400 nanometers; and
a transfer device operable to apply at least one of heat and pressure to the transfer medium and the image receptive medium to effect transfer of the image from the transfer medium to the image receptive medium through diffusion or sorption.

22. A method of making an imaged material comprising the steps of:
depositing an image receptive layer on a substrate, the image receptive layer comprising a polymeric binder and a plurality of partially translucent light scattering particles having an average size of less than 400 nanometers, and
applying an image to said image receptive layer through at least one of diffusion and sorption.

23. The image receptive medium of claim 1, wherein at least a portion of the particles are zinc oxide.

24. The image receptive medium of claim 1, wherein at least a portion of the particles are aluminum oxide.

25. The image receptive medium of claim 1, wherein said particles have a refractive index of about 1.9.
